(19) United States
(12) Patent Application Publication
(10) Pub. No.: US 2007/0071202 A1
(43) Pub. Date: Mar. 29, 2007

(54) Server apparatus

(75) Inventors: Yasumasa Sasaki, Tachikawa-shi (JP); Shigeru Fukazawa, Hachioji-shi (JP); Koji Shima, Sagamihara-shi (JP); Fumikazu Matsukawa, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/474,147

(22) Filed: Jun. 23, 2006

(30) Foreign Application Priority Data
Jun. 30, 2005 (JP) 2005-193058

(51) Int. Cl. H04N 7/14; H04M 1/00

(52) U.S. Cl. 379/158; 348/14.04

(57) ABSTRACT

According to one embodiment, a server apparatus includes a memory which stores a management table indicating a correspondence relation between the terminal IDs contained in a call information event from the telephone exchange apparatus and status information indicating the call connected status of the telephone terminals, when the call connection is established between telephone terminals, a decision unit to refer to the management table based on terminal IDs contained in the received call information event and decides the presence or absence of a change in the call connected status of telephone terminals corresponding to the terminal IDs, and a controller which updates the status information corresponding to the terminal IDs in the management table, when the decision by the decision unit is presence, and establishes a data communication connection between data terminals associated with the terminal IDs of telephone terminals to be connected, based on the updated status information.

### CROSS-REFERENCE TO RELATED APPLICATIONS

This application is based upon and claims the benefit of priority from Japanese Patent Application No. 2005-193058, filed Jun. 30, 2005, the entire contents of which are incorporated herein by reference.

### BACKGROUND

1. Field

One embodiment of the invention relates to a server apparatus for use in a visual communication system configured such that the server is connected to two or more telephone exchange apparatuses which are interconnected by private lines to allow video signals and computer data as well as voice signals to be handled.

2. Description of the Related Art

An in-house network system are used in offices and factories. The in-house network system is configured such that a telephone exchange apparatus, such as a private branch exchange (PBX) or a key telephone apparatus, accommodates telephones as extension terminals and provides switched connection between the extension terminals and an external communication network, such as a public network, and between the extension terminals, thereby allowing telephone calls to be made.

Recently, a system has also been proposed which is configured such that a server, which has video telephone terminals and data terminals, such as personal computers, connected to it, is connected to telephone exchange apparatuses through transmission lines to allow a telephone-based voice communication system and a server-based data communications system to operate conjointly (see, for example, Japanese Patent Publication No. 8-321889).

With such a system in which the telephone exchange apparatuses and the server are parallel, a service has also been strongly demanded in which a data communication connection between data terminals is established when a connection is made between telephone terminals to build video conferences. With the above system, however, a data terminal-to-data terminal session is initiated in association with the call status of telephone terminals and data is shared between data terminals. At present, a visual communication system which provides additional services such as video conferences is still under study and is not realized.

It is expected that a visual communication system is realized by replacing a data terminal with a server (see, for example, Japanese Patent Publication No. 2000-174925). In this case, visual communication control has to be performed on the data terminal side according to the call status of telephone terminals, thus increasing the burden of control processing. For this reason, general-purpose computers cannot be used for data terminals, resulting in increasing of the cost to built the system.

In order to realize the above visual communication system, it is required to examine the following measures:

That is, the visual communication system is generally configured such that a VCS (Visual Communication System) server receives a call information event (originating device information, terminating device information) transmitted from a telephone exchange apparatus when the call status of telephone terminals connected to the telephone exchange apparatus changes, then analyzes the connected state of the telephone terminals based on the call information event and instructs data terminals which are associated with the telephone terminals to initiate/end visual communication based on the connected status.

However, depending on call processing services of the telephone exchange apparatus, sufficient device information of one of the telephone terminals may not be obtained from a call information event from the exchange apparatus.

For example, at the initiation of a two-party call, device information of the party at the other end can be obtained from a call information event. After the visual communication has been temporarily stopped through a call information event sent at the time of initiating visual communication and holding the call, if no information of the party at the other end is contained in a call information event sent upon releasing the holding, the visual communication cannot be resumed.

With a telephone exchange apparatus which supports a multi-line service in which one telephone device accommodates two or more lines or a multi-appearance service in which two or more telephone devices share one line, if device information of the other party cannot be obtained from a call information event, it becomes further difficult to identify the other party.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram of a visual communication system according to a first embodiment of the present invention;

FIG. 2 is a block diagram illustrating a functional configuration of the VCS server in the first embodiment;

FIG. 3 shows an example of the stored contents of the connection information management table shown in FIG. 2;

FIG. 4 shows an example of the stored contents of the extension terminal to VC (Visual Client) mapping table shown in FIG. 2;

FIG. 5 shows an example of the stored contents of the session information management table shown in FIG. 2;

FIG. 6 schematically shows a sequence of operations of transmitting and receiving information among the extension terminals, the VCS server, and the data terminals when visual communication control is carried out in the first embodiment;

FIG. 7 is a flowchart illustrating the control procedure of the VCS server when visual communication control is carried out in the first embodiment;

FIG. 8 shows a sequence illustrating an example of an operation from the time when the holding state is set to the time when the holding state is released in the first embodiment; and

FIG. 9 shows a sequence of operations in a three-party call in a second embodiment of the present invention.

### DETAILED DESCRIPTION

Various embodiments according to the invention will be described hereinafter with reference to the accompanying drawings. In general, according to one embodiment of the invention, a server apparatus which receives call information including terminal IDs specifying a plurality of telephone terminals to perform call connections by a telephone exchange apparatus executing exchange processing among a plurality of telephone terminals, and which links data communication connections at data terminals associated with the plurality of the telephone terminals, respectively, with the call connections, the server apparatus comprising: a memory which stores a management table indicating a correspondence relation between the terminal IDs contained in a call information event from the telephone exchange apparatus and status information indicating the call connected status of the telephone terminals, when the call connection is established between telephone terminals; a decision unit to refer to the management table based on terminal IDs contained in the received call information event and decides the presence or absence of a change in the call connected status of telephone terminals corresponding to the terminal IDs, at the time of receiving a call information event; and a controller which updates the status information corresponding to the terminal IDs in the management table, when the decision by the decision unit is presence, and establishes a data communication connection between data terminals associated with the terminal IDs of telephone terminals to be connected, based on the updated status information.

### First Embodiment

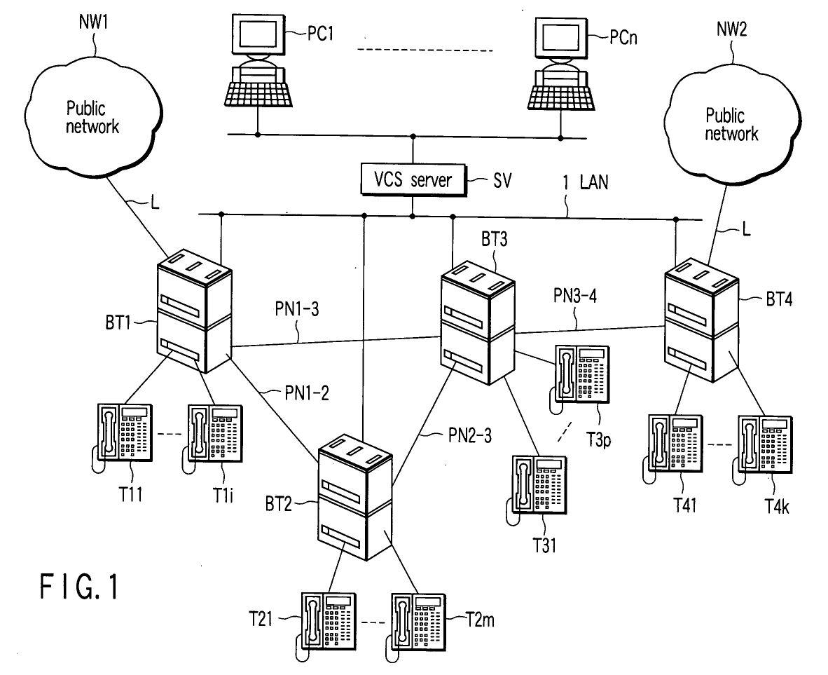

FIG. 1 is a schematic diagram of a visual communication system according to a first embodiment of the present invention.

This system is equipped with main devices BT1 to BT4 which are interconnected by private lines PN1-2, PN1-3, PN2-3, and PN3-4. The main devices BT1 to BT4 accommodate extension terminals T11 to T1i, T21 to T2m, T31 to T3p, and T41 to T4k, respectively, via extension lines. The main devices BT1 and BT4 are connected to public networks NW1 and NW2, respectively, via local lines L.

The main devices BT1 to BT4 are connected to a local area network (LAN) 1 to which a VCS (Visual Communication System) server SV is connected. The VCS server SV accommodates two or more data terminals PC1 to PCn each of which is comprised of a general-purpose personal computer. The data terminals PC1 to PCn are adapted to operate in association with the extension terminals T11 to T1i, T21 to T2m, T31 to T3p, and T41 to T4k.

The VCS server SV performs an additional function for the main devices BT1 to BT4, for example, the VCS server processes media information such as video information.

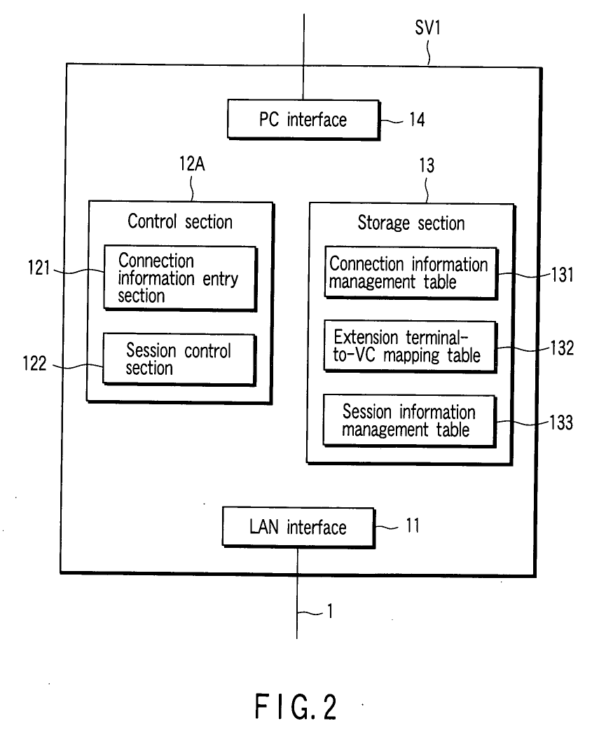

FIG. 2 is a functional block diagram of the VCS server SV.

The VCS server SV is provided with a LAN interface section 11, a control section 12, a storage section 13, and a PC interface section 14. The LAN interface section 11 serves as an interface with the LAN 1.

The PC interface section 14 severs as an interface with the data terminals PC1 to PCn.

The storage section 13 stores routing information required for connection control of the control section 12. The storage section 13 is further provided with a connection information management table 131 (hereinafter referred to simply as the table 131), a extension terminal-to-VC (Visual Client) mapping table 132 (hereinafter referred to simply as the table 132), and a session information management table 133 (hereinafter referred to simply as the table 133).

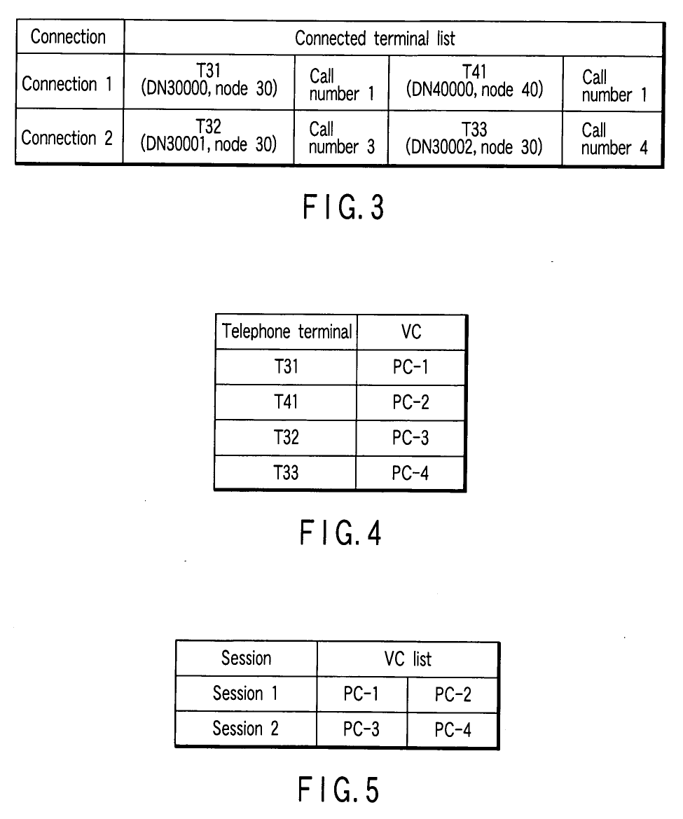

The table 131 is stored, as shown in FIG. 3, with data representing association among device information (DN, node ID), call numbers, and status information indicating the connected status of the respective extension terminals T11 to t1i, T21 to T2m, T31 to T3p, and T41 to T4k.

In the description which follows, we assume that the extension terminals comprise T31, T32, T33, and T41 and the data terminals comprise PC1 to PC4.

The table 132 is stored, as shown in FIG. 4, with information indicating association between the extension terminals (telephone terminals) T31, T32, T33, and T41 and the data terminals (VC) PC1 to PC4. When connected with the VCS server SV, each of the data terminals PC1 to PC4 informs the server of its associated extension number. The VCS server SV updates the contents of the table 132 in accordance with the received information.

The table 133 is stored, as shown in FIG. 5, with information indicating data terminal-to-data terminal sessions.

On the other hand, the control section 12 is provided, as shown in FIG. 2, with a connection information entry section 121 and a session control section 122 as new functions according to the present invention in addition to the functions of control of the status of the data terminals PC1 to PCn and control of the linkage operation of the data terminals PC1 to PCn and extension terminals T11 to T1i, T21 to T2m, T31 to T3p, T41 to T4k.

By analyzing a call information event informed from the main device BT3, the connection information entry section 121 decides that a connection has been established between, for example, the extension terminals T31 and T41, then adds or updates information on connection 1 in the table 131.

When receiving a call information event indicating the hold status of the extension terminal T31 from the main device BT3 while a connection has been set up between the extension terminals T31 and T41, the session control section 122 updates the status information “connection 1” in the table 131 to “hold”. Based on the updated status information, the session control section 122 reads from the table 132 that the extension terminals T31 and T41 are associated with the data terminals PC1 and PC2, respectively and then retrieves the session state of the data terminals PC1 and PC2 from the table 133. For example, in a case where the data terminals PC1 and PC2 are to initiate communication from now on, the session control section 122 controls the data terminals PC1 and PC2 to initiate a session. After the session has been established between the data terminals PC1 and PC2, the session control unit 122 updates the stored contents of the table 133.

The operation of the visual communication system thus configured will be described next.

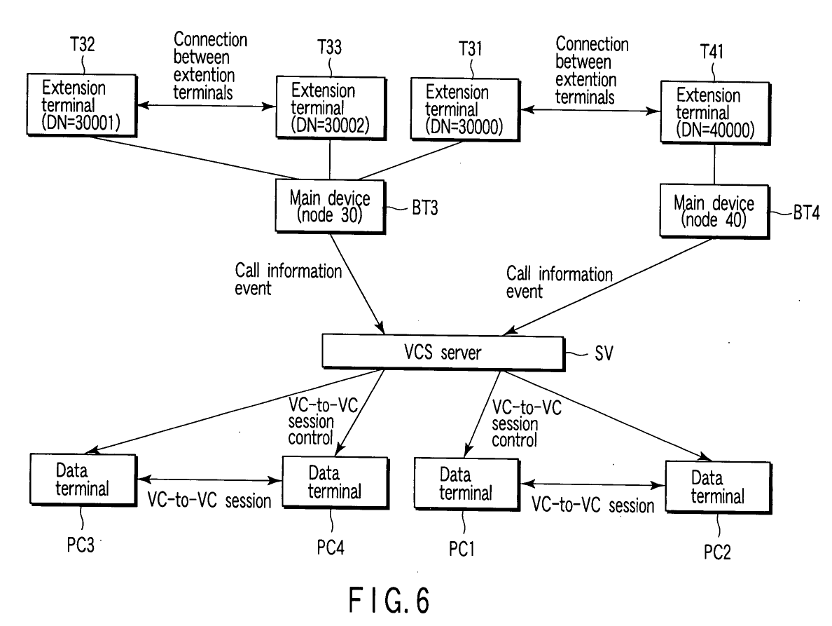

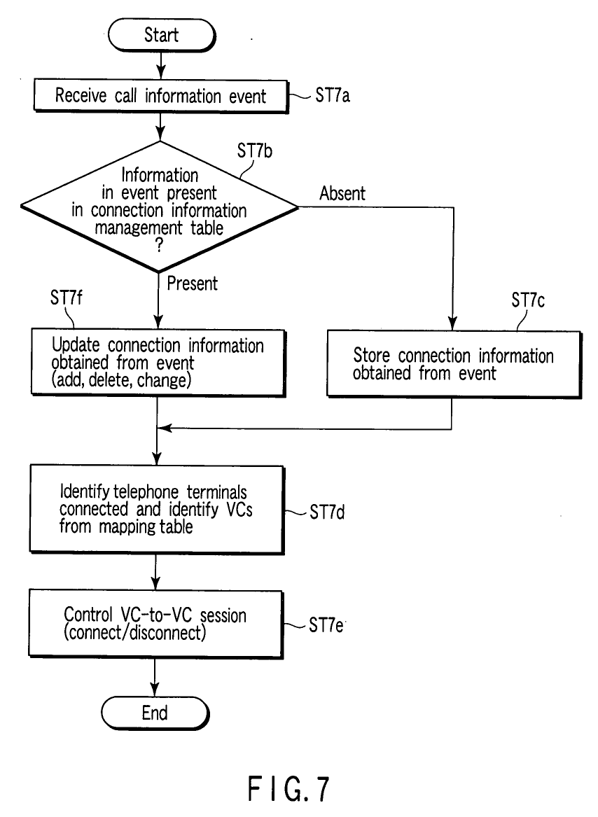

FIG. 6 is a schematic diagram illustrating a sequence of operations of transmitting and receiving information among the extension terminals T31, T32, T33 and T41, the main devices BT3 and BT4, the VCS server SV, and the data terminals PC1 to PC4 at the time of execution of visual communication control. FIG. 7 is a flowchart illustrating the procedure of executing the visual communication control by the VCS server SV.

(Calling Operation from Extension Terminal T31 to Extension Terminal T41)

Suppose that the user at the extension terminal T31 dials “4040000” in order to make a call to the user at the extension terminal T41. Then, a request to establish communication is sent from the extension terminal T31 to the main device BT3. Upon receipt of this request to establish communication, the main device BT3 transfers the request to the main device BT4 over the IP private line PN3-4, which in turn calls the terminating extension terminal T41. When the extension terminal T41 responds to the call, a communication link is established between the extension terminals T31 and T41.

Then, the user at the extension terminal T31 becomes enabled to have a conversation with the user at the extension terminal T41.

The VCS server SV receives a call information event from the main device BT4 at the node on the terminate side (block ST7a) and then makes a decision of whether the originating device information (DN, node ID, call number) and the terminating device information (DN, node ID, call number) contained in the call information event are present or absent in the connection information management table 131 (block ST7b).

Since it is time to initiate a conversation, the decision is absence. The VCS server SV then stores the connection information “connection 1”, the originating device information, and the terminating device information obtained from the call information event into the table 131 so that they are associated with one another (block ST7c).

Based on the connection information “connection 1”, the VCS server SV reads from the mapping table 132 that the extension terminals T31 and T41 are associated with the data terminals PC1 and PC2, respectively (block ST7d) and then retrieves the session state of the data terminals PC1 and PC2 from the table 133.

Since it is time to initiate communication, the VCS server SV controls the data terminals PC1 and PC2 to initiate a session (block ST7e). After a session has been established between the data terminals PC1 and PC2, the VCS server SV updates the stored contents of the session information management table 133.

Thus, the user at the extension terminal T31 becomes enabled to automatically initiate video communication with the data terminal PC2 using the data terminal PC1 by simply operating the terminal T31.

[Operation of Releasing the Holding Status]

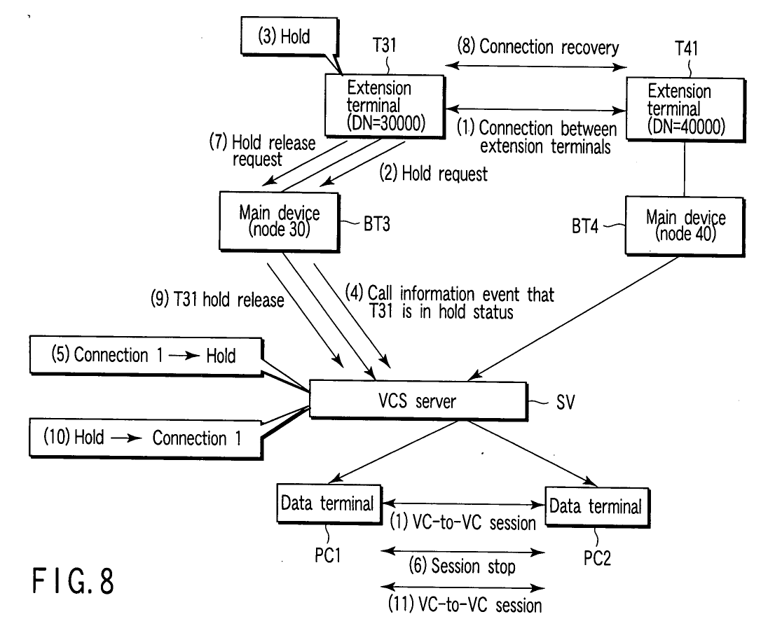

Suppose now that a conversation is being been held between the users at the extension terminals T31 and T41 as shown in FIG. 8.

Suppose that, in this state, the user at the extension terminal T31 performs an operation of making a request to hold ((2) in FIG. 8). Then, the hold request is sent from the extension terminal T31 to the main device BT3. Upon receipt of the hold request, the main device BT3 holds the communication link with the extension terminal T41 ((3) in FIG. 8) and sends to the VCS server SV a call information event indicating that the extension terminal T31 is in the hold status ((4) in FIG. 8).

Upon receipt of the call information event, the VCS server SV makes a decision of whether the device information (DN, node ID, and call number) for the extension terminal T31 contained in the call information event is preset or absent in the table 131. Since the device information is present in the table at this point, the procedure goes from block ST7b to block ST7f to rewrite the connection information for the extension terminals T31 and T41 in the table 131 from “connection 1” to “hold” ((5) in FIG. 8). Upon updating the table 131, the PC1-to-PC2 session is stopped temporarily ((6) in FIG. 8).

Suppose that the user at the extension terminal T31 has performed an operation of making a request to release the hold status. Then, the release request is sent from the extension terminal T31 to the main device BT3 ((7) in FIG. 8). Upon receipt of this request, the main device BT3 recovers the connection between the extension terminals T31 and T41 ((8) in FIG. 8) and sends to the VCS server SV a call information event indicating that the extension terminal T31 has been released from the hold status ((9) in FIG. 8).

Upon receipt of the call information event, the VCS server SV first makes a decision of whether the device information (DN, node ID, call number) of the extension terminal T31 contained in the call information event is present or absent in the table 131. Since it is present at this point, the VCS server SV rewrites the connection information of the extension terminals T31 and T41 in the table 131 from “holding” to “connection 1” ((10) in FIG. 8). Upon updating the table 131, the server establishes a PC1-to-PC2 session ((11) in FIG. 8).

According to the first embodiment, as described above, when a communication link between the extension terminals T31 and T41 is established, the device information (DN, node ID, call number) and the status information of the respective extension terminals T31 and T41 contained in a call information event from the main device BT4 are stored in the table 131 in the VCS server SV with correspondence established therebetween. On the occurrence of a hold request or a hold release request from the extension terminal T31, the corresponding status information in the table 131 is updated from “connection 1” to “hold” or from “hold” to “connection 1” based on the device information of T31 contained in a call information event and the device information of T31 in the table 131. Using the updated status information and the device information of the respective extension terminals T31 and T41 in the table 131, a session is established between the data terminals PC1 and PC2 which are associated with the data terminals T31 and T41, respectively.

Therefore, even if a call information event that does not contain the device information of the other party is received from the main device BT3 or BT4.

Suitable visual communication can be performed with ease to operate the extension terminals T31 and T41 and the data terminals PC1 and PC2 conjointly through the use of information concerning the extension terminals T31 and T41 stored in the table 131.

In addition, in the first embodiment, the server SV compares the call numbers of the respective extension terminals T31 and T41 with the call numbers stored in the table 131 prior to updating of the status information in the table 131 and then makes a decision of whether to update the corresponding status information or add new status information. Thus, a suitable status information updating process can be performed for each call status of the extension terminals T31 and T41.

### Second Embodiment

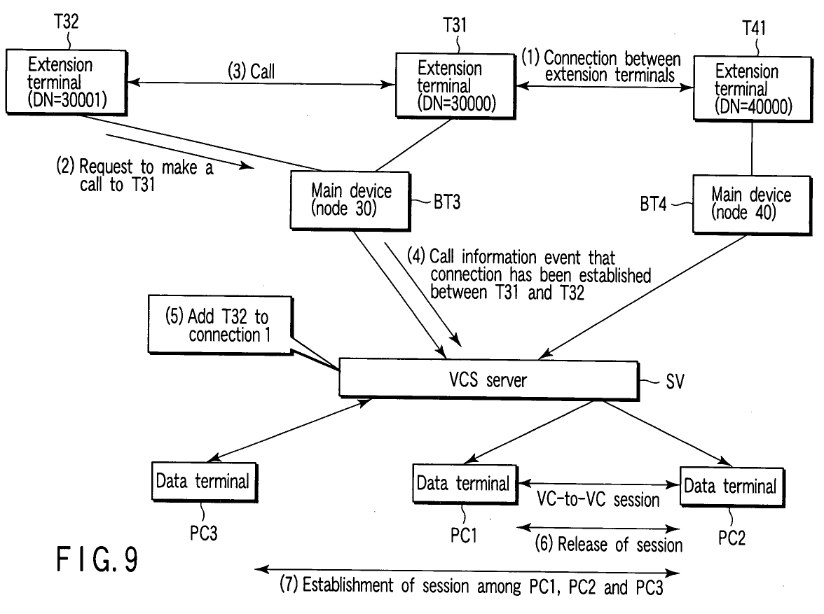

FIG. 9 shows a sequence of operations when the extension terminal T32 makes an interrupt call while a connection is established between the extension terminals T31 and T41 as a second embodiment of the present invention. In FIG. 9, corresponding parts to those in FIG. 8 are denoted by like reference numerals.

Suppose now that a connection has been established between the extension terminals T31 and T41 ((1) in FIG. 9).

In this state, suppose that the user at the extension terminal T32 makes a request to make a call to the extension terminal T31 ((2) in FIG. 9). Then, the call request is sent from the extension terminal T32 to the main device BT3. Upon receiving this request, the main device BT3 calls the terminating extension terminal T31 while holding the communication link with the extension terminal T41. If the extension terminal T31 responds to the call, a communication link is formed between the extension terminals T31 and T32 ((3) in FIG. 9). A call information event indicating that a connection has been established between the extension terminals T31 and T32 is sent to the VCS server SV ((4) in FIG. 9).

Upon receipt of the call information event, the VCS server SV first makes a decision of whether the device information (DN, node ID, call number) of the extension terminal T32 contained in the call information event is present or absent in the table 131. Since it is absent at this point, the VCS server SV stores the device information of the extension terminal T32 together with the extension terminals T31 and T41 in “connection 1” in the table 131 with correspondence established among them ((5) in FIG. 9). Upon updating the table 131, the server releases the PC1-to-PC2 session ((6) in FIG. 9) and then establishes a session among the data terminals PC1, PC2, and PC3 ((7) in FIG. 9).

In the second embodiment as well, like the first embodiment, suitable visual communication can be performed with ease to operate the extension terminals T31, T32 and T41 and the data terminals PC1, PC2 and PC3 conjointly through the use of information concerning the extension terminals T31, T32 and T41 stored in the table 131.

### Other Embodiments

The present invention is not limited to the embodiments described above. Although the first and second embodiments have been described in terms of an example of connecting the main devices through private lines, they may be connected through communication networks as opposed to private lines.

In addition, the first and second embodiments have been described in terms of applications of establishing data terminal sessions in the cases where the hold state is released and a third party makes an interrupt call. However, the present invention is applicable to other call processing services.

Furthermore, the configuration and type of the VCS server, the type of the telephone exchange apparatuses, the type of the extension terminals, the type of the data terminals, the stored contents of the tables, and the data terminal session control method can be variously modified without departing from the scope of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information including terminal IDs specifying a plurality of telephone terminals to perform call connections by a telephone exchange apparatus executing exchange processing among a plurality of telephone terminals, and which links data communication connections at data terminals associated with the plurality of the telephone terminals, respectively, with the call connections, the server apparatus comprising:
a memory which stores a management table indicating a correspondence relation between the terminal IDs contained in a call information event from the telephone exchange apparatus and status information indicating the call connected status of the telephone terminals, when the call connection is established between telephone terminals;
a decision unit to refer to the management table based on terminal IDs contained in the received call information event and decides the presence or absence of a change in the call connected status of telephone terminals corresponding to the terminal IDs, at the time of receiving a call information event; and
a controller which updates the status information corresponding to the terminal IDs in the management table, when the decision by the decision unit is presence, and establishes a data communication connection between data terminals associated with the terminal IDs of telephone terminals to be connected, based on the updated status information.

2. The server apparatus according to claim 1, when one of first and second telephone terminals which have been placed in the call connected status is switched from the call connected status to the hold status and then the hold status is released,
wherein the controller updates the status information of the first and second telephone terminals in the management table from the hold status to the original call status, and then establishes a data communication connection between first and second data terminals associated with the first and second telephone terminals based on the updated status information.

3. The server apparatus according to claim 1, when receiving a call information event concerning a request by a third telephone terminal to connect to first and second telephone terminals which have been placed in the call connected status,
wherein the controller updates the status information in the management table to status information indicating the call connected status of the first, second and third telephone terminals, and establishes a data communication connection among first, second and third data terminals associated with the terminal IDs of the first, second and third telephone terminals based on the updated status information.

4. The server apparatus according to claim 1, wherein the controller compares the terminal IDs contained in the call information event received from the telephone exchange apparatus with the terminal IDs in the management table, and updates the status information corresponding to the terminal IDs, only when a coincidence occurs.
